(19) United States
(12) Patent Application Publication
(10) Pub. No.: US 2020/0037110 A1
(43) Pub. Date: Jan. 30, 2020

(54) APPARATUS FOR EXCHANGING REMOTE DEALING SYSTEM BASED ON LOCATLITY AND PROXIMITY OF CONTROL DEVICE TO REMOTE SENSING SOURCING DEVICE

(71) Applicant: Ho Man Sham, Hong Kong (HK)

(72) Inventor: Ho Man Sham, Hong Kong (HK)

(21) Appl. No.: 16/047,014

(22) Filed: Jul. 27, 2018

(51) Int. Cl. H04W 4/029; G08B 21/24; G06K 7/10

(52) U.S. Cl. CPC H04W 4/029; H04L 67/18; G06K 7/10366; G08B 21/24

(57) ABSTRACT

A personal RFID lost and found mobile apparatus and methods useful for tracking luggages during traveling, the luggages are typically stored out-of-sight and signal needs to pass thru obstacles. The invention may be used with a single tag, as well as more than one tag for the tracking of multiple items. A RFID tag replies with information regarding the whereabout of the tag. A GPS locator replies with information regarding geolocation of a RFID reader. A processor connected to the RFID reader infers a distance point according to which the RFID passive tag respond, the magnitude and phase of the returned signals, and the geolocation of the GPS locator. A series of the distance points to the passive tag are stored in a memory for extrapolation to determine the last known geolocation of the passive tag. Upon determining the distance to the passive tag exceeds a preset value, the last known geolocation of the passive tag is presented to assist in locating lost items.

### FIELD OF THE INVENTION

The present invention relates to a system and device for tracking items. Specifically, this invention relates to tracking luggages during traveling when the luggages are stored out-of-sight and signal needs to pass through obstacles.

### BACKGROUND OF THE INVENTION

It is a conventional understanding that it is not possible to accurately determine the physical distance to a passive RFID tag according to standard when reading it with a tag reader. It is also a conventional understanding that while it is possible to estimate a distance to a passive RFID tag, the end precision is almost always rendered inaccurate due to many circumstantial factors, such as reader and tag performance, the quality of the software and the resources invested in such a software. This is especially true in the case of a single reader, and/or when there is not a clear line of sight to the tag from the reader. Known techniques have been devised to improve the accuracy in mainly one of two ways. The first one relies on signal strength, while the second one relies on using the time the response is received to an inquiry (time difference of arrival between tags). Techniques that uses a combination of both through triangulation and trilateration are also known in the field. RTLS, RSSI, TDOA represent some of the commonly known techniques. This invention enables tracking of a personal item without using triangulation or trilateration and thus making it possible to provide tracking of geolocation of a personal item by means of as few as a single passive tag, while readily support a tracking system in which more than one passive tag can be utilized for the tracking of multiple personal items. Comparing to other known personal tracking systems, such as those that make use of Bluetooth, RFID is more well suited to equip with personal items when travelling as they are more cost effective to manufacture, more convenient to use and reuse, as they do not need battery, and can be smaller in size and weight. As such, a lost item prevention system is needed that can be used with RFID and provide reminders of the last known geolocation of RFID tags.

In the current marketplace, it is often desirable to provide supplemental forms of advertising and information dissemination at the same point of presence where the personal items are in transit with travelers. Such information typically has been in the form of business cards, pamphlets, brochures, coupons registration forms, and similar items available at a nearby location.

In addition to physical materials, the modern version of a business card/brochure has been a web site. Thus, the content being shown on display screens has been designed to present a web site address (URL). This required travelers to see and remember the address until they were able to take the time to visit it at a later point. This presented an issue, as relying on the travelers to remember the website and take the time to visit limits its usefulness. With the wide spread adoption of mobile devices, a new form of business card was developed—that being the RFID Code and other similar optical codes that could be photographed using the built in camera on the mobile device. This would allow travelers to photograph the image of the code and then link to the associated website directly.

One of the benefits for display screen programmers is that the format and technology gives the programmer unlimited canvas that can be updated and changed at anytime. The limitation then becomes the amount of time a traveler will see the screen and be able to ingest the content. Therefore any references to supplemental content (e.g. a web site or RFID Code) must be able to be easily seen by the traveler and available for a long enough time so that they can utilize it. If the traveler is required to perform a task with the screen, this time must also be accounted for. This presents a major issue for screen programmers when the screen itself will only be seen for a short period of time or where there is a desire to have programming that moves at a faster pace through say a series of short visual ads.

Another limitation of supplemental content linking (e.g., a web site or RFID Code) via display screens has been sub-optimal physical limitations. An advertisement with a brand/logo may be easily seen from a distance, from various angles, or in passing. However this does not always work well with traveler flow in public spaces. Furthermore, there are social limits in how far a traveler will go to link to for example a RFID Code that requires them to stand out, aim their camera with some level of accuracy and make one or more attempts to scan the RFID Code using their mobile device camera. RFID Codes become difficult to use because of the required position and re-positioning of the camera to capture the image in as still a manner as possible. Users must be within very close proximity and at the correct angle to the RFID Code—within inches if the RFID code is small and not presented in a full-screen manner on a larger screen. What was seen as a simple technology that would overcome the requirement of a traveler remembering a web site can be an exercise in frustration. If you add in the fact that the screen content may be changing at all times, the traveler may only have a short amount of time to scan the code before another visual is presented on the screen.

It is often a case of whether the traveler will have the time and inclination to carry out the different tasks to access the related content at that time or whether they will wait until they can do so at their leisure. This limits the use of any in-store or location based related materials such as special offers/coupons, etc.

“RFID fingerprinting” technology has also gained popularity. It does an analysis and compares the RFID sample against a database of known RFID files. If it finds a match it is able to know where in an RFID-visual presentation that segment was found. While this technology is quite suitable for in-home use and in quieter environments, it is largely impractical for use in public spaces or environments where noise levels are not fixed.

This technology has most of the limitations of RFID fingerprinting also making it impractical in some situations. However, the present invention does discuss its use in very specific ways to enhance but not limit the present technologies.

### SUMMARY OF THE INVENTION

A personal RFID lost and found mobile apparatus and methods useful for tracking luggages during traveling, the luggages are typically stored out-of-sight and signal needs to pass thru obstacles. The invention may be used with a single tag, as well as more than one tag for the tracking of multiple items. A RFID tag replies with information regarding the whereabout of the tag. A GPS locator replies with information regarding geolocation of a RFID reader. A processor connected to the RFID reader infers a distance point according to which the RFID passive tag respond, the magnitude and phase of the returned signals, and the geolocation of the GPS locator. A series of the distance points to the passive tag are stored in a memory for extrapolation to determine the last known geolocation of the passive tag. Upon determining the distance to the passive tag exceeds a preset value, the last known geolocation of the passive tag is presented to assist in locating lost items.

The invention enables content which is related to content being displayed on a display screen or provided by another RFID source to be fully synchronized with the static content that is being shown on the display screen or RFID from an RFID speaker. In this regard, content which is related is content which is provided based on the content that is being shown on a display screen or RFID from an RFID speaker. That is, the related content need not be in the same form or have the same or similar subject matter. Additionally, as used herein, content is related if it is provided in response to content that is being shown on the display screen or RFID from an RFID speaker. Simply by pressing a button on a mobile device, or otherwise activating software on the device, relevant and targeted offer transfers based on content being shown on the display screen or played by the RFID speaker is provided to the mobile device via a server. No Wi-Fi or Bluetooth® connection is needed. The signals from a RFID® beacon can be used as trigger as explained below.

The system presented can work alone without any communication between the mobile device and display screens or other RFID sources wherever located; it is based on a mobile device to server communication of the mobile device location and, optionally, the time of day. Based on the time, when needed, and communicated location, the server can determine what content is on the display screen and can therefore serve synchronized offers. It works passively with periodic regular updates of the mobile device location or actively through the use of a button (touch screen, keyboard, etc.) on the mobile device to signal the server to check its location and therefore identifying which display screen or other RFID source the mobile device is near.

The uniqueness of the technology relies on proximity and, when necessary, time of day to completely synchronize the content on display screens or other RFID source with mobile devices and enables sharing and syncing of content on the RFID source which include, by way of example, TV sets, ATM machines, casino gaming device display screens, display screens in retail stores stadiums, amphitheaters, airports or other public places without the need of a Wi-Fi, or Bluetooth® connection, or data connection to a wireless carrier. Such display screens may or may not be digital and may or may not be able to transmit data to another device such as a server. Display screens with communications ability enable additional features of the invention to be utilized, but such communications ability is not required in many situations. In an embodiment, a display screen includes static displays which contain the same content over an extended period of time such as a billboard. In the case of such static displays, since the displayed content is relatively fixed or static, the related content delivered to the mobile device does not depend on time of day as is the case with RFID content which changes over relatively short periods of time. The static display can send these triggers to the consumer's mobile device based on location, via RFID embedded in RFID tones, via GPS location technologies, via Bluetooth® beacons or any other location based technology available today or in the future. There are several different implementations and embodiments for the present invention, however at a minimum level it provides a method and apparatus allowing for the determination of a consumer's proximity to a particular display screen or other RFID source. Furthermore it can determine the content being shown on every display screen or other RFID source in the system so that it can then deliver to the consumer related content on their mobile device. It does this in a manner that is extremely simple and can be accomplished passively or actively.

The following examples show several uses of the technology. They are by no means all encompassing and are presented to illustrate some of the possible uses. In all cases, a consumer downloads a software application for the mobile device designed to transmit the present location of the mobile device and send/receive content from a server. The application can be a generic application which works with substantially all display screens or other RFID source which are part of the network connected to the server, or a specialized application, e.g., a travel app, specifically tailored to display screens in certain location, e.g., airports.

Seamless transfer of digital information from device to device without the need for additional hardware, Wi-Fi connectivity or Bluetooth®.

### BRIEF DESCRIPTION OF THE DRAWINGS

FIG. 1 is a schematic diagram of a method of transforming a series of distance points and geolocations into last known location comprising an embodiment of the present invention;

FIG. 2 is a flow chart illustrating a method of transforming a series of distance points and geolocations into last known location comprising an embodiment of the present invention;

FIG. 3 is a schematic diagram showing information processors, consistent with embodiments of the present invention.

FIG. 4 refers to a system diagram showing the interaction among RFID readers, consistent with embodiments of the present invention.

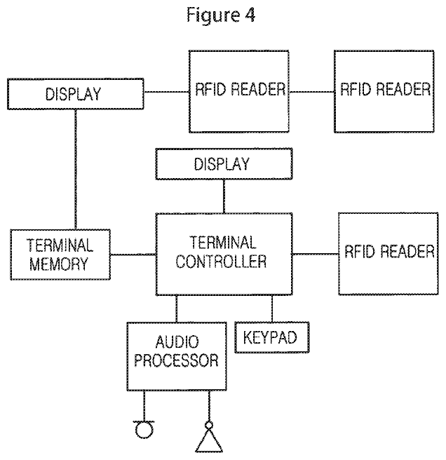

FIG. 5 refers to a system diagram showing the interaction between RFID readers and a mobile device, consistent with embodiments of the present invention.

FIG. 6 refers to a system diagram showing the interaction between a mobile device and the content lookup server, consistent with embodiments of the present invention.

FIG. 7 refers to a system diagram showing the interaction among the servers, consistent with embodiments of the present invention.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

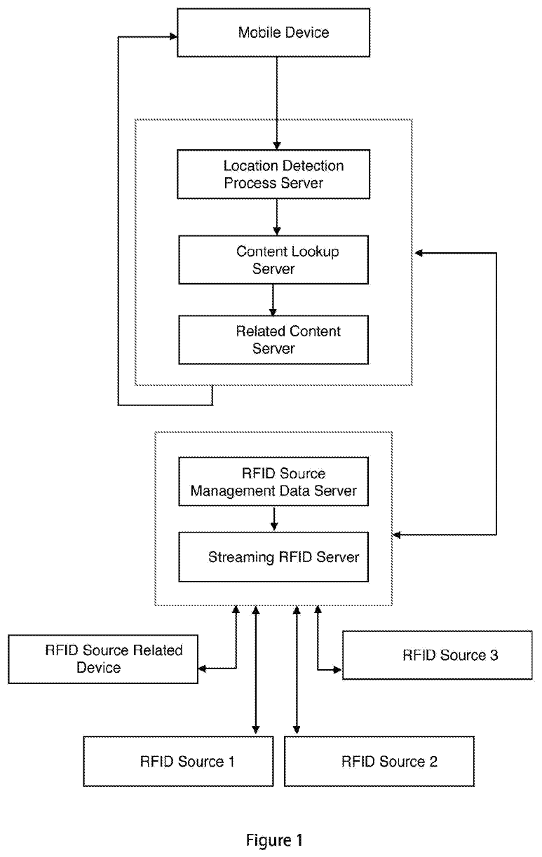

The present invention makes use of the following elements shown in FIG. 1.

RFID Source is referred throughout as RFID tag, RFID source or source. The minimum requirement is that these devices must be capable of receiving an RFID only stream by way of a streaming server. In most cases, the streaming server is a remote device and the RFID feed is provided over a network. FIG. 1 shows three RFID sources as RFID source 1, RFID source 2 and RFID source 3, but of course any number of RFID sources can be provided. If the display screen has static content, then no RFID is needed, but an RFID feed can be provided by an RFID tag nearby. This is shown in FIG. 1 as RFID source related device.

RFID Source Management Data Server

One or more RFID source management data servers contain information on the location of each and every display device or other RFID source in the system. This information can be updated manually by an operator or in an automated manner as is described and detailed in the various implementations. For static displays and RFID only sources, the location of the display or RFID source can also be provided to the RFID source management data server.

Streaming RFID Server

The use of one or more RFID servers provide display screens or other RFID source with access to pre-recorded and/or RFID streams made available by the operator. The use of streaming RFID content is presently in wide use. The content can contain a combination of any RFID content that is capable of being viewed on one or more display screens or one or more other RFID sources.

Mobile Device

These presently include mobile smart phones, tablets, and other electronic devices capable of data communications, receiving and displaying information for the consumer from a remote server, and transmitting user input to a remote server. In addition, these devices must be able to provide geographical location of the device in real-time.

Location Detection Processing Server

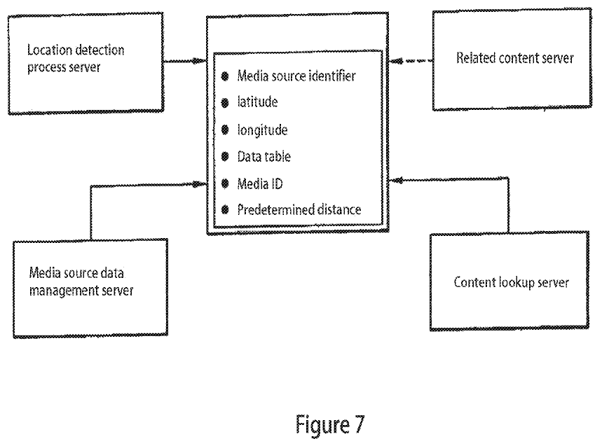

Referring to FIG. 7, a variety of location services are in wide use in software and via the Internet at this point in time. These services provide software API's and “Web Services” for effectively locating a position anywhere on earth using longitude and latitude coordinates. It is a common practice to perform calculation of distances between two sets of co-ordinates to determine proximity to another location or object. Location detection processing server utilizes location information provided by a mobile device's use of such location services.

Content Lookup Server and Related Content Processing

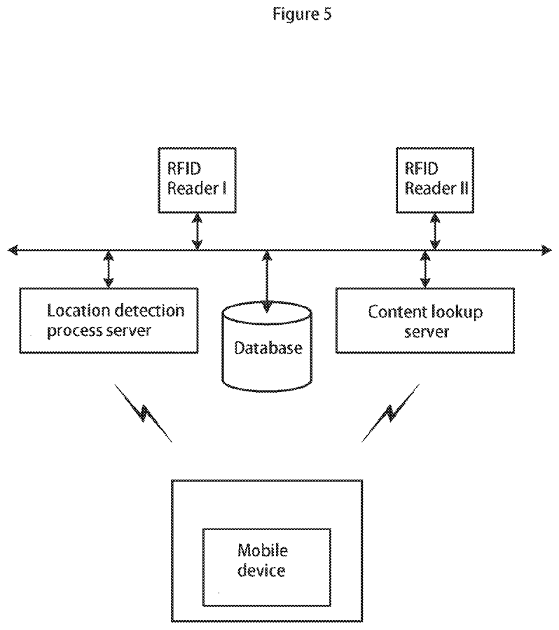

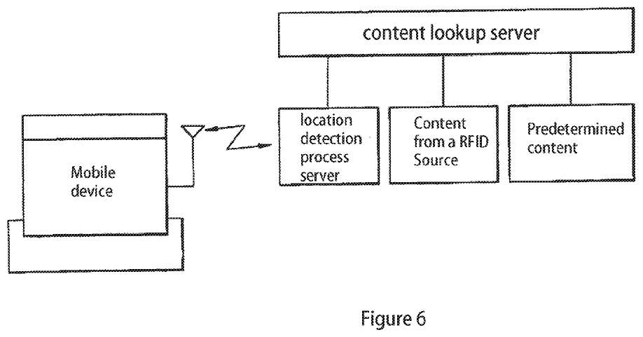

Referring to FIGS. 5 and 6, Related content can be any form of data that can be sent to and processed by a mobile device for either direct use/display/playback, storage, or further consumer interaction. There are references throughout the different embodiments that refer to coupons, forms, images, offers, and interactive content. Any and all of this content is relevant and related to the streaming or static content being displayed on one or more display screens, or RFID provided by an RFID tag at any time.

Implementation Details

Display Service—One or more streaming RFID servers connected to a private or public communications network provide access to data related to the location of individual RFID sources. The information contained within the data tables on server includes at a minimum the following details:

RFID Source ID—A unique identifier for a RFID source.

Longitude—A numeric value related to a specific longitude of each RFID source.

Latitude—A numeric value related to a specific latitude of each RFID source.

Last Start Time—A time value representing the last time the RFID was started on the streaming data server. For a static display, the last start time value is not needed or it could be the date the content was last changed.

Content ID—Details on static content, or RFID content including time code and identification codes related to specific content available from a content server.

When a RFID source is initiated, it communicates with streaming RFID server sending it a request for a specific RFID content ID as programmed by the operator. Upon receiving the request, the server begins to stream the requested RFID content to the RFID source. At the beginning of the stream initialization, server may set the “Last Start Time” in a screen location data table located on server as the present time on the server.

Related Content Service—One or more related content servers connected to a private or public communications network provide access to a content data related to one or more RFID which are identified by a specific content ID which is unique for each RFID stream. The information contained within the data tables on related content server includes at a minimum the following details:

RFID Source ID—This directly corresponds with the identification of a specific display screen or RFID RFID source.

Content ID—An identification of the static content being shown on the display or being played by an RFID RFID source such as an RFID speaker.

Time(s)—One or more times (specific time(s)/date(s) or time/date range(s) for the static content being shown on the display or played by an RFID speaker.

Related Data—The content from related content server to be served to the mobile device.

The streaming RFID server and related content server may be separate physical servers or contained on a single physical server. In all cases, the data that is available on server and on server is shared and accessible by both servers.

Location Detection Process—One or more location detection process servers connected to a private or public data communications network provide the ability to determine the nearest location of a display screen or RFID source based on a given longitude and latitude of a mobile device and the location of the display screen or RFID source.

Mobile devices include any device which is capable of a) sending its present longitude/latitude, b) communicating with remote servers via communications networks, c) sending requests to a remote server, and d) receiving and displaying data/information received from a remote server.

Each such device contains a client application capable of processing data specific to the application and utilizes the capabilities of the specific device. The specifics of such application are not important to an understanding of the invention and the requirements to write code for such applications are well within the abilities of persons skilled in the art based on the descriptions provided herein.

Each mobile device has a unique client ID and uses an existing location service such as GPS, Bluetooth® beacon, WiFi or any other location based technology to determine its current latitude/longitude. The ID and location are the minimum required information needed to be provided by each mobile device. The ID represents the individual mobile device, the longitude and latitude represent its present location. As the mobile client changes locations, its longitude/latitude are updated and sent to location detection process.

At the point where the mobile device requests synchronization with a particular RFID source, it sends its client ID and its present location (longitude/latitude coordinates) to location detection process.

Upon receiving a request, location detection process calculates the distance between the mobile device and the nearest location of known operating RFID source. If one is within range of the mobile device, content lookup performs an additional lookup of related data on related content server. The range can vary based on screen size, location and other factors.

In the case of a display screen which is not in a fixed location, in addition to the use of a sophisticated display screens of the type described below with reference to embodiment 2, other mechanisms such as GPS can be used to provide location information. Thus, in an automobile with an entertainment system, the location of the automobile, and, therefore, its display screen, can be provided by its GPS system.

At any point where a mobile device has made a synchronization request with location detection process server and the server has determined the nearest RFID source, server performs a lookup using content lookup server. The content lookup server and related content server may be on the same physical server or on a separate server. In either case the information from both servers is available to the RFID source management data server which may also be part of the same server or a separate server.

Using the RFID source ID identified as the nearest display screen location, the RFID source management data server looks up the RFID content ID and Last Start Time which corresponds to the stream being played and the time on the server when the RFID source first began playing the RFID stream.

The RFID source management data server performs a calculation using the present time and subtracting the start time to determine the time difference.

Using the above data, RFID source management data server can now perform a lookup of related content for the specific RFID stream ID and a timecode matching the present time in the RFID by using the display ID, RFID ID, and RFID stream timecode as the key to related data in RFID source.

The returned data is sent from related content server and corresponds to the specified time, RFID stream, and RFID source based on the initiating request from RFID management data server. This data can be any related data and is not of a defined type.

It is important to note that a single stream can have content that is unique to each specific display screen location allowing for localization of offers and content.

RFID sources are devices capable of displaying/presenting static displays, or playing RFID contained on one or more of the following sources—a RFID stream delivered via a private or public network, a physical (fixed or removable) mobile device. RFID sources may be capable of sending and receiving instructions and information from the display service as described above. Specifically, through these instructions, the streaming RFID service knows what content is being displayed on the RFID source display screen or being played by the RFID source RFID speaker at any time. If the RFID source display screen displays only static content which cannot be updated by delivery of a stream, then no streaming RFID service is needed.

In other embodiments, the RFID source management data server instead of performing a lookup of related content for the specific RFID stream ID and a timecode matching the present time in the RFID, by using the RFID source ID as the key to related data in RFID source, the RFID source or other device related to the RFID source can send its location and content to the RFID source management data server and content lookup server. That is, the same information which is generated by these devices can instead be provided directly by the display or a related RFID source by providing the content and location. Such information can be provided by any device programmed with the content and location information which can then send the information to the servers with an indication that no special content processing is necessary other than to associate the provided location with the provided content. That is, a related device is any device which provides content information for a particular display. For example, for a static billboard, the related device, which could be located anywhere, could periodically send content being displayed on such display, and its location to RFID source management data server, in this manner, once the mobile device sends its request and location, the provided content and device location is processed by related content server and the determined related content is sent to the mobile device.

Users of the present invention use a mobile device with a suitable “client application” (software program). The client application sends its location (longitude and latitude) to the location detection process server. This can be done by one or more of the following methods:

a) The mobile device, via the client application, can periodically send the location of device.

b) The user can interact with the client application and request that the application send its present location.

The location detection process server determines the approximate distance of the mobile device from the location of RFID sources. Based on the location of the nearest RFID source, the service determines whether it is possible for the user to be within viewing or RFID range of the RFID source.

If it is determined that the possibility exists for the user to be in viewing range or RFID range of the display or speaker, the client application is provided with related content from the related content server specific to the content presently viewable hearable from RFID source in the viewing listening range of the user. The related content can include of one or ore RFID, or text.

The client application uses its internal programming to present the related content to the user. The content is unlimited, however it might include additional related RFID files, bar-codes, etc. It is however, directly related to the location of the RFID source that was originally viewed or listened to.

The client application can further process the received content based on the type of content and interaction with the user. Examples at this point in the process might include storing the content for future use, accessing a deeper level of content pertaining to the related content, sharing the content with others, sending the content to another device (e.g. a printer), etc.

Servers can be operated from a single physical server, be spread among multiple physical servers, or may reside on a cloud-based computing service. The data the servers access and use in processing requests may be contained on the same server in a machine readable format or can be stored on separate database server.

Strategically placed RFID sources present still RFID at predefined times. As noted above, each RFID source has a unique identifier and can present content which is unique to that location or identical to that which is provided by other RFID sources in multiple locations.

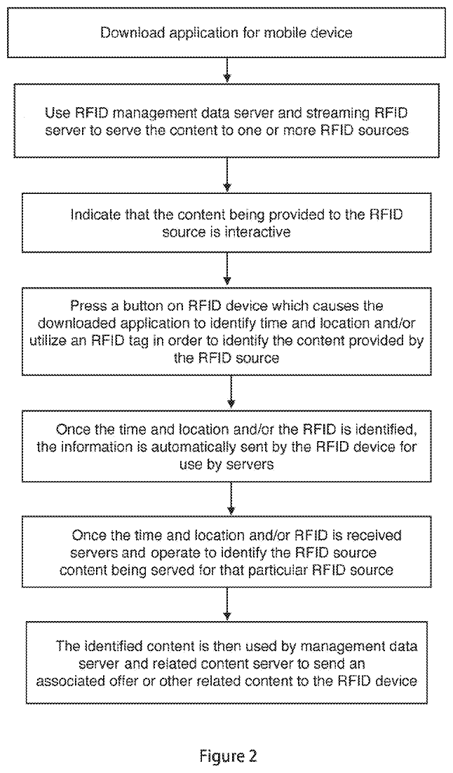

Referring now to FIG. 2, the following steps may be utilized to practice the invention as described herein. Initially, an application is downloaded for mobile device, which application is designed to perform the mobile device processing described herein. As noted above, such program although used by the invention does not form a part thereof, and is easily implemented by persons having ordinary skill in the art based on the descriptions provided herein.

RFID management data server and streaming RFID server are used to serve the content for display or play on one or more RFID sources. Preferably, there is an indication that the content being shown or played on the RFID source is interactive so as to signal a user with a mobile device that additional information can be downloaded. Such indication may be a logo placed in a corner of the screen or the like.

Pressing a button (soft or hard) on mobile device causes the downloaded application to identify time and location and/or utilize an RFID tag in order to identify the content being shown or played on the RFID source. Alternatively, the signal could be sent by shaking or otherwise moving the mobile device using motion sensor devices built into the mobile device.

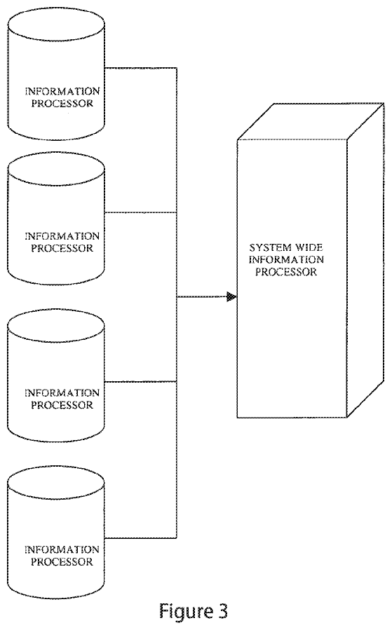

Once the time and location and/or the RFID is identified, the information is automatically sent by the mobile device for use by servers, as shown in FIG. 3.

Once the time and location and/or RFID is received, servers and operate to identify the content being served or being displayed for that particular RF ID source.

The identified content is then used by RFID source management data server and related content server to send an associated offer or other related content to the mobile device.

1. A personal RFID lost and found mobile device useful for tracking luggage during traveling, the luggages are typically stored out-of-sight and signal needs to pass thru obstacles, comprising:
a. a passive RFID tag;
b. a RFID reader, wherein said RFID reader is a conventional RFID ranging device means for measuring distance whose output is the distance (H) between a first data subject and the reader is to be measured;
c. a processor, mounted to said RFID reader, wherein the processor infers a distance between the RFID passive tag and the RFID reader, where p is the power for near field, where f is frequency operated, P att is the magnitude of power attenuator, d is the distance between the RFID passive tag and the reader;
d. a GPS locator, coupled to the RFID reader, wherein the GPS locator provides a geo-sensor location of the RFID reader;
e. a location detection process server configured to receive location information from said mobile device and determine a location of a nearest one of said at least one RFID source, and determine whether the mobile device is within a predetermined distance from said determined location;
f. a content lookup server coupled to said location detection process server configured to determine if predetermined content exists which corresponds to content provided by said at least one RFID source at said determined location and said mobile device is determined to be within said predetermined distance;
g. a RFID source data management server configured to operate incoordination with said location detection process server, said content lookup server, and a related content server to cause said related content server to send data to said mobile device which is related to said content provided by said RFID source at said determined location if said mobile device is determined to be within said predetermined distance, wherein
said RFID source has a corresponding media source ID embodied therein, and
said content has a corresponding media ID embodied therein;
h. a first memory for storing a series of geolocations of the RFID reader, a series of corresponding determined distance values, and a geolocation of the tag determined based on the extrapolation of the geolocations and the distance values; and,
i. a memory storing instructions configured to be executed by the processor to implement a lost and found tracking method, wherein the processor further
obtains from the first memory a last known geolocation of the RFID passivetag,
obtains from the processor a current distance to determine if the current distance exceeds a preset value, and
reports of the last known geolocation of the RFID passive tag when the current distance exceeds the preset value.

2. The system defined by claim 1 wherein said location detection process server determines the location of the nearest one of said at least one media source by accessing a data table maintained by said media source data management server which contains a media source identifier and a latitude and longitude for each of said at least one media source.

3. The system defined by claim 1 wherein said content lookup server and said RFID source data management server operate to determine if said related content server includes data which is related to said content on said media source at said determined location using a media source ID corresponding to said media source, and a media ID corresponding to said content.

4. The system defined by claim 3 wherein said media source data management server further operates to perform a lookup of related content for said content provided by said media source corresponding to a media ID by using the media source ID, and the media ID.

5. The system defined by claim 4 wherein said media source data management server further operates to instruct said related content server to send said related content data to said mobile device determined to be within said predetermined distance using a related content table having records wherein for each media ID, there is a corresponding media source ID and a corresponding related content ID.

6. The system defined by claim 1 wherein said related content is provided to said mobile device by one of said mobile device initiating a request for said related data by a pulling operation and said related data being pushed to said mobile device without a specific request being initiated by said mobile device.

7. The system defined by claim 1 wherein upon determining that said mobile device is within said predetermined distance, said RFID source data management server sends a signal to said mobile device to sample an audio signal from said media source or a device related to said media source to identify said media source content and send said identified media source content to said media source data management server which operates in cooperation with said related content server to send data to said mobile device which is related to said content being provided by said media source as determined by said sampled audio signal.

8. The system defined by claim 1 wherein said media source content is identified by a predetermined uniform resource locator to identify a network resource containing said content provided by said RFID source.

9. The system defined by claim 1 where said at least one RFID source has a moving location which location is dynamically provided to said location detection process server.

10. The system defined by claim 1 wherein said mobile device provides said location information in response to a trigger signal.
